(19) United States
(12) Patent Application Publication
(10) Pub. No.: US 2012/0173187 A1
(43) Pub. Date: Jul. 5, 2012

(54) METHOD AND APPARATUS FOR EVALUATING PERFORMANCE OF MOBILE TERMINAL

(75) Inventors: Woo Kwang Lee, Suwon-si (KR); Dong Kun Shin, Suwon-si (KR)

(73) Assignee: SAMSUNG ELECTRONICS CO. LTD., Suwon-si (KR)

(21) Appl. No.: 13/324,415

(22) Filed: Dec. 13, 2011

(30) Foreign Application Priority Data
Jan. 5, 2011 (KR) 10-2011-0000718

(51) Int. Cl. G06F 19/00; G06F 11/34

(52) U.S. Cl. 702/123

(57) ABSTRACT

A method and an apparatus for evaluating performance of a mobile terminal are provided. The method for evaluating performance of a mobile terminal includes: executing applications of a preset list, extracting storage approach patterns for the executed applications, generating test scenarios for the executed applications using the extracted storage approach patterns, performing benchmarking tests for the applications using the generated test scenarios, and evaluating the mobile terminal based on results of the performed benchmarking tests.

### PRIORITY

This application claims the benefit under 35 U.S.C. §119(a) of a Korean patent application filed on Jan. 5, 2011 in the Korean Intellectual Property Office and assigned Serial No. 10-2011-0000718, the entire disclosure of which is hereby incorporated by reference.

### BACKGROUND OF THE INVENTION

1. Field of the Invention

The present invention relates to a method and an apparatus for evaluating performance of a mobile terminal More particularly, the present invention relates to a method for analyzing storage approach patterns for applications installed in a mobile terminal to evaluate performance of the mobile terminal, and an apparatus implementing the same.

2. Description of the Related Art

Recently, with increased use of a mobile terminal, the mobile terminal has become popular. The mobile terminal may provide functions such as a unique voice call service, various data transmission services and various additional services, and has been used as a multimedia communication device.

There are various types of mobile terminals and performance differs according to type. In general, upon evaluating the mobile terminal, clocks of a Central Processing Unit (CPU), the size of a memory, capacity of a battery, and a type of LCD are evaluated. The time taken to execute 1 MB read/write/copy or 10 KB×100 files read/write/copy in a storage installed in the mobile terminal is measured to evaluate performance of the mobile terminal.

A variety of applications are provided in the mobile terminal Since a method for evaluating performance as illustrated above is not a method based on an Input/Output (I/O) pattern upon driving a real application, it is difficult to determine that an evaluation result objectively reflects performance of a mobile terminal.

### SUMMARY OF THE INVENTION

Aspects of the present invention are to address at least the above-mentioned problems and/or disadvantages and to provide at least the advantages described below. Accordingly, an aspect of the present invention is to provide a method for evaluating performance of a mobile terminal capable of reflecting the performance of the mobile terminal, and an apparatus thereof.

In accordance with an aspect of the present invention, a method for evaluating performance of a mobile terminal is provided. The method includes executing applications of a preset list, extracting storage approach patterns for the executed applications, generating test scenarios for the executed applications using the extracted storage approach patterns, performing benchmarking tests for the applications using the generated test scenarios, and evaluating the mobile terminal based on results of the performed benchmarking tests.

In accordance with another aspect of the present invention, a mobile terminal is provided. The mobile terminal includes a storage unit for storing at least one application and benchmarking program, an approach pattern extracting unit for extracting storage approach patterns by executed applications, an approach pattern analyzing unit for generating test scenarios for the executed applications using the extracted storage approach patterns, a test performing unit for performing benchmarking tests by applications using the generated test scenarios, and a performance evaluating unit for evaluating performance of the mobile terminal using results of the performed benchmarking tests.

Exemplary embodiments of the present invention generate a test scenario using an approach pattern indicating how to approach a storage unit for every executed application and perform a benchmarking test using the generated test scenario. That is, since the present invention generates a test scenario according to an approach pattern by directly executing an application, it may reflect a real application operation. Accordingly, the present invention may evaluate performance of the mobile terminal more exactly and objectively.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating a configuration of a mobile terminal according to an exemplary embodiment of the present invention;

FIG. 2 is a view illustrating a protocol stack of a benchmarking system according to an exemplary embodiment of the present invention;

FIG. 3 is a flowchart illustrating a method for evaluating performance of a mobile terminal according to an exemplary embodiment of the present invention;

FIG. 4 is a view illustrating a data format of a storage access pattern according to an exemplary embodiment of the present invention;

FIG. 5 is a view illustrating a data format of a test scenario according to an exemplary embodiment of the present invention;

FIG. 6 is a flowchart illustrating a procedure for benchmarking tests for applications using generated test scenarios according to an exemplary embodiment of the present invention;

FIG. 7 is a flowchart illustrating a procedure for evaluating performance of a mobile terminal using results of performed benchmarking tests according to an exemplary embodiment of the present invention;

FIG. 8 and FIG. 9 are views illustrating execution screens of a benchmarking program according to an exemplary embodiment of the present invention; and

FIG. 10 is a view illustrating an execution screen of a benchmarking program according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As used herein, the term “Benchmarking” denotes an operation and a system for measuring and evaluating performance of a mobile terminal Concretely, the Benchmarking is an operation for measuring and evaluating performance of a file system in the mobile terminal. As used herein, the term “Benchmarking program” denotes an application for evaluating performance of a mobile terminal and is stored in a storage unit in the mobile terminal As used herein, the term “Benchmarking test” denotes a test that executes an application according to a test scenario to measure execution time and evaluates performance of the mobile terminal for the measured execution time.

As used herein, the term “File System” denotes a system approaching a storage installed in the mobile terminal In the mobile terminal, if an application approaches a file system, the file system approaches a flash memory as the storage through a Flash Translation Layer. The file system may include a File System Driver (FSD) Manager, a Cache Manager, an Extended File Allocation Table ExFAT file system, a Disk Cache, a Partition Driver, and a Block Driver.

The mobile terminal according to an exemplary embodiment of the present invention may be an information communication device and a multimedia device such as a Portable Multimedia Player (PMP), a Personal Digital Assistant (PDA), a Smart Phone, or a Moving Picture Experts Group (MPEG)-1 or MPEG-2 Audio Layer 3 (MP3) player.

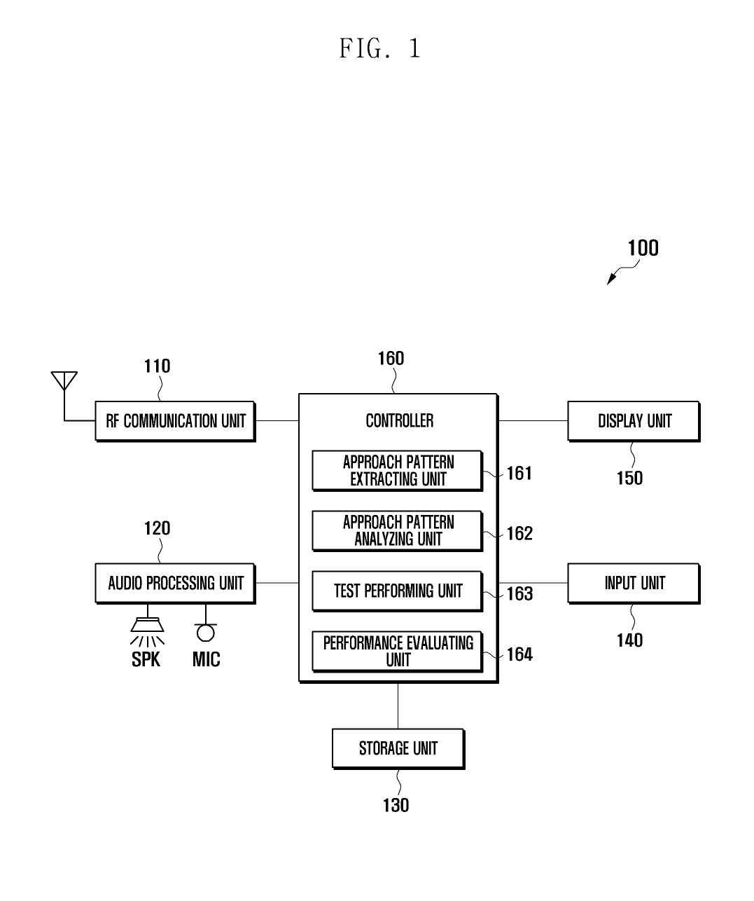

FIG. 1 is a block diagram illustrating a configuration of a mobile terminal according to an exemplary embodiment of the present invention.

Referring to FIG. 1, the mobile terminal 100 includes a Radio Frequency (RF) communication unit 110, an audio processing unit 120, a storage unit 130, an input unit 140, a display unit 150, and a controller 160.

The RF communication unit 110 performs transmitting and receiving functions of corresponding data for RF communication. The RF communication unit 110 may include a transmitter (not illustrated) for up-converting a frequency of a transmitted signal and for amplifying the signal, a receiver (not illustrated) for low-noise-amplifying a received signal and for down-converting the signal. Further, the RF communication unit 110 receives data through an RF channel and outputs the received data to the controller 160. The RF communication unit 110 may transmit data output from the controller 160 through the RF channel.

The audio processing unit 120 may be configured by a COder-DECoder (CODEC). The CODEC may include a data CODEC processing packet data and an audio CODEC processing an audio signal. The audio processing unit 120 converts a digital audio signal into an analog audio signal using the audio CODEC, and plays the analog audio signal using a Speaker (SPK). The audio processing unit 120 converts an analog audio signal input from a Microphone (MIC) into a digital audio signal using the audio CODEC.

The storage unit 130 stores programs and data necessary for an operation of the mobile terminal 100. The storage unit 130 may be divided into a program area and a data area. The program area stores a program for controlling an overall operation of the mobile terminal 100, an Operating System (OS) booting the mobile terminal 100, and other applications. The other applications may include an Internet browser application, a map searching application, a music and video playing application, a photographing application, and a moving image photographing application, and the like. The data area is an area for storing data created according to use of the mobile terminal 100, and may store images, moving images, phone-books, audio data, and the like.

The storage unit 130 according to an exemplary embodiment of the present invention may be configured by a flash memory. More particularly, the flash memory may be configured by an Embedded NAND Flash Memory such as an iNAND or a moviNAND. In a case of the iNAND, a Flash Translation Layer is mounted as a Firmware, read speed is 30 MB/sec, write speed is 12 MB/sec, and a driving voltage of 3.3V is required. Maximum capacity of the moviNAND is 32 GB, maximum speed thereof is 52 MB/sec, and the moviNAND requires a driving voltage of 3.3V.

The storage unit 130 also stores a benchmarking program for measuring performance of the mobile terminal 100. Further, the storage unit 130 stores a list of applications to be executed, information on storage approach patterns for applications, information regarding test scenarios for applications upon execution of a benchmarking program, and information regarding weights applied by applications upon evaluating of performance.

The input unit 140 receives a key operation signal of a user for controlling the mobile terminal 100 and transfers the received key operation signal to the controller 160. The input unit 140 may be configured by a key pad such as a 3*4 pad or a QWERTY pad including numeral keys, character keys, and arrow keys or a touch panel. Further, the input unit 140 may be configured by a button key, a jog key, a wheel key, and the like. The input unit 140 generates and transfers an input signal executing applications (e.g., a call function, a music playing function, a moving image playing function, an image display function, a camera photographing function, or a Digital Multimedia Broadcasting (DMB) output function) of the mobile terminal according to user input.

The display unit 150 may be configured by a Liquid Crystal Display (LCD), an Organic Light Emitting Diode (OLED), or an Active Matrix Organic Light Emitting Diode (AMOLED). The display unit 160 visibly provides a menu of the mobile terminal 100, input data, function setting information, and a variety of other information to a user. The display unit 150 performs a function for outputting a booting screen, an idle screen, a menu screen, a call screen, and other application screens of the mobile terminal 100. The display unit 150 also separates and displays representative times of respective applications corresponding to benchmarking test execution results by applications. Further, the display unit 150 displays a benchmarking test result screen including a performance score of the mobile terminal 100.

The controller 160 controls an overall operation with respective structural elements of the mobile terminal 100. The controller 160 includes an approach pattern extracting unit 161, an approach pattern analyzing unit 162, a test performing unit 163, and a performance evaluating unit 164.

The approach pattern extracting unit 161 extracts storage approach patterns for executed applications. Upon executing applications, the approach pattern extracting unit 161 hooks a file system to extract storage approach patterns for applications. A file system stage in a protocol stack of a storage approach is located under an application stage. The approach pattern extracting unit 161 retrieves an approach pattern between the application stage and the file system stage. The storage approach pattern may include a current time after booting the mobile terminal, an elapsed Time of operation, a type (Read/Write) of operation, a Start Sector which an Input/Output (I/O) Request approaches, and the Sector Size.

The approach pattern analyzing unit 162 generates test scenarios for executed applications using the extracted storage approach pattern. The approach pattern analyzing unit 162 determines a statistic value on whether the size of approached data is small or large, and a statistic value on whether an approach location is sequential or random to generate a test scenario with respect to how to benchmark. The test scenario may include Test IDentification (ID), a Start Sector, a Sector Size, a type (Read/Write) of operation, a Delay Time with next test, and an application name.

The test performing unit 163 performs benchmarking tests for applications using the generated test scenarios. The test performing unit 163 according to an exemplary embodiment of the present invention performs the benchmarking test using the generated test scenarios with respect to an application executed for extracting a storage approach pattern, performs tests for applications, for preset times, to measure test performing times, determines an average of the test performing times, and determines the determined average as representative time of a corresponding application.

The performance evaluating unit 164 evaluates performance of a mobile terminal 100 using results of the performed benchmarking test. The performance evaluating unit 164 verifies weights allotted by applications in which a benchmarking test is performed from the storage unit 130, applies a corresponding weight to the determined representative times of applications, respectively, determines an average of representative times of applications to which the weight is applied, and evaluates a score corresponding to the determined average as performance of the mobile terminal.

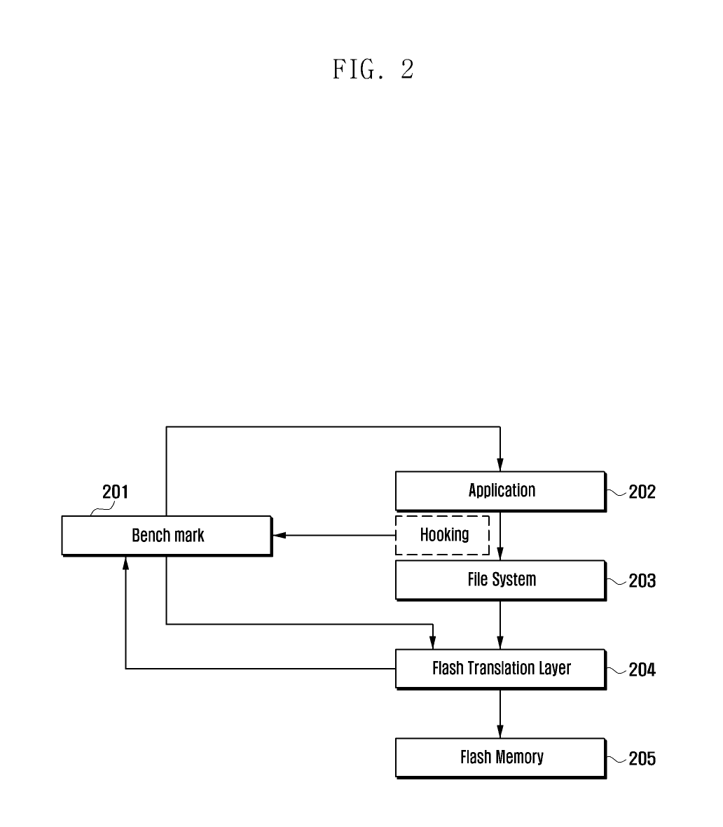

FIG. 2 is a view illustrating a protocol stack of a benchmarking system according to an exemplary embodiment of the present invention.

The protocol stack of a benchmarking system consists of a benchmark 201, an application 202, a file system 203, a flash translation layer 204, and a flash memory 205.

The benchmark 201, the application 202, the file system 203, and the flash translation layer 204 are software layers, and the flash memory 205 is a hardware layer.

The file system 203 may be configured by a File Allocation Table 32 (FAT32) file system, or an ExFAT file system. The sector size in the ExFAT file system may use 512˜4096 bytes, and 2,796,202 files may be stored in one directory.

A procedure for evaluating performance of a mobile terminal 100 according to an exemplary embodiment of the present invention is performed in the benchmark 201. The approach pattern extracting unit 161, the approach pattern analyzing unit 162, the test performing unit 163, and the performance evaluating unit 164 are included in the benchmark 201.

If the benchmark 201 executes an application 202, the application 202 approaches a file system 203. At this time, the benchmark 201 hooks a pattern that an application 202 approaches between the application 202 and the file system 203 to extract an approach pattern. The benchmark 201 extracts a current time after booting the mobile terminal, an elapsed Time of operation, a type (Read/Write) of operation, a Start Sector that I/O Request approaches, and a Sector Size as the approach pattern, and temporarily stores them.

The benchmark 201 generates a test scenario using approach patterns extracted for applications 202. The benchmark 201 applies the generated scenarios to the flash translation layer 204 to perform the benchmarking test, and receives a benchmarking test performing result from the flash translation layer 204. The benchmark 201 performs a benchmarking test for one application, for preset times, to retrieve a plurality of test performing results from the flash translation layer 204. The test performing result corresponds to an elapsed time of test performing.

The benchmark 201 determines representative times for applications using a plurality of test performing results from the flash translation layer 204. The benchmark 201 determines an average of test performing times measured for applications and determines the average thereof as a representative time of a corresponding application.

The benchmark 201 evaluates performance of the mobile terminal 100 using the determined representative time of an application. The benchmark 201 applies weights to representative times for applications, determines an average of representative times of an application to which the weights are applied, and evaluates performance of the mobile terminal 100 with a score corresponding to the determined average thereof.

The foregoing exemplary embodiment of the present invention has described an internal construction of the mobile terminal evaluating performance and the protocol stack of a benchmark system. Hereinafter, a method for evaluating performance in the mobile terminal 100 will be described.

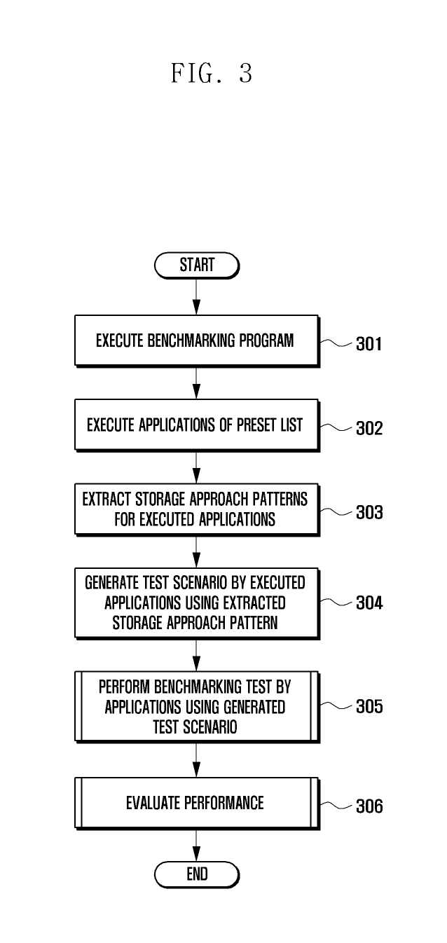

FIG. 3 is a flowchart illustrating a method for evaluating performance of a mobile terminal according to an exemplary embodiment of the present invention.

Referring to FIG. 3, a controller 160 executes a benchmarking program stored in a storage unit 130 at step 301. The benchmarking program refers to an application for evaluating performance of the mobile terminal 100. A benchmarking program execution menu is included in the mobile terminal 100, and a user may execute the benchmarking program through an input unit 140 using the benchmarking program execution menu.

If the benchmarking program is executed according to user input, the controller 160 executes applications of a preset list at step 302. In order to evaluate the performance of the mobile terminal 100, the present invention executes at least one application installed in the mobile terminal 100 to extract a storage approach pattern. At this time, the executed application may be configured by the most frequently used applications in the mobile terminal 100. The controller 160 constructs one list with the most frequently used applications. When executing the benchmarking program, the controller 160 may execute applications included in the list. The application list may be fixed or changed according to a user setting. Further, upon execution of the applications, the controller 160 may measure an execution frequency for every application and reflect a rank of the execution frequency to construct the application list. The controller 160 may execute five applications, namely, an Internet Browser application, a Map searching application, a Music & Video application, a camera photographing application, and a moving image (e.g., a camcorder) application at step 302.

After executing one or more applications, an approach pattern extracting unit 161 extracts storage approach patterns for executed applications at step 303. Referring to FIG. 2, after the approach pattern extracting unit 161 in the benchmark 201 executes the application 202, it hooks a file system to extract storage approach patterns for the applications. The storage approach pattern may be composed of a current time after booting the mobile terminal, an elapsed Time of operation, a type (Read/Write) of operation, a Start Sector that I/O Request approaches, and a Sector Size.

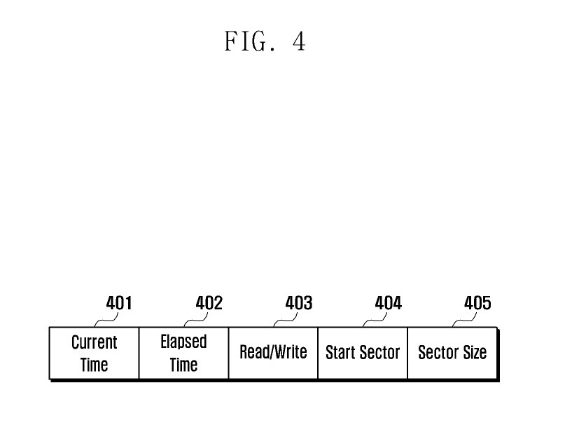

FIG. 4 is a view illustrating an example of a data format of a storage access pattern according to an exemplary embodiment of the present invention.

Referring to FIG. 4, the data format of a storage approach pattern includes a Current Time region 401, an Elapsed Time region 402, a Read/Write region 403, a Start Sector region 404, and a Sector Size region 405. The Current Time region 401 includes a current time after booting the mobile terminal 100. The Elapsed Time region 402 includes time taken to perform an operation such as Read, Write, or Copy. The Read/Write region 403 includes a type of operation indicating whether I/O is read or write. The Start Sector region 404 includes an occurrence location of the I/O or a Logical Sector Address. The Sector Size region 405 includes the size of a sector in which the I/O occurs.

In an exemplary implementation, the approach pattern extracting unit 161 may additionally extract ‘input/output occurrence time’ as the storage approach pattern. The storage approach pattern is classified into a continuous pattern in which a next I/O comes directly after one I/O finishes, a pause pattern having rest time during the I/O operation, and a burst pattern generating many I/Os once and having rest time during the I/O operation.

If the approach pattern extracting unit 161 extracts the storage approach patterns, the approach pattern analyzing unit 162 generates test scenarios for executed applications using the extracted storage approach patterns at step 304. To objectively evaluate performance of the mobile terminal 100, the performance of the mobile terminal 100 is not directly evaluated based on the extracted storage approach pattern itself, but the approach pattern analyzing unit 162 generates test scenarios with the extracted storage approach patterns. That is, the approach pattern analyzing unit 162 determines statistic values on whether the size of approached data is small or large and on whether an approach location is sequential or random to generate the test scenarios. The test scenario may include a Test ID, a Start Sector, a Sector Size, a type (Read/Write) of operation, a Delay Time with a next test, and an application (App) name.

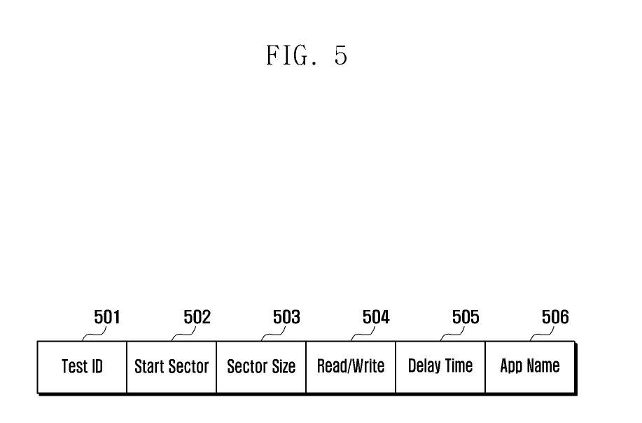

FIG. 5 is a view illustrating an example of a data format of a test scenario according to an exemplary embodiment of the present invention.

Referring to FIG. 5, the data format of a test scenario includes a Test ID region 501, a Start Sector region 502, a Sector Size region 503, a Read/Write region 504, a Delay Time region 505, and an App Name region 506. The Test ID region 501 includes a unique identification of a test. The unique identification of the test may be an order of tests. The Start Sector region 502 includes an occurrence location of I/O, a Logical Sector Address, or a Logical Block Address. The occurrence location of I/O may contain information on whether the occurrence location is sequential, random, linearly increased or reduced, and on whether a partition is designated.

The Sector Size region 503 may include the size of a sector in which I/0 occurs, and information on whether the size of data is small or large. For example, a small data size may be 10 KB, and a large data size may be 1 MB.

The Read/Write region 504 includes a type of operation indicating whether I/O is read or write. The Delay Time region 505 includes time intervals between tests. The App Name 506 includes an application name.

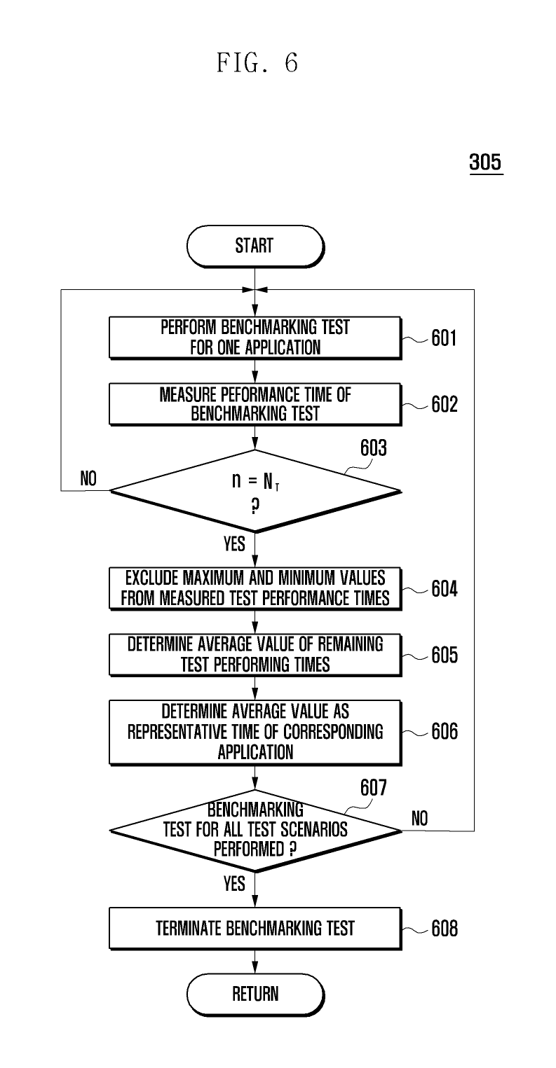

If the approach pattern analyzing unit 162 generates test scenarios for applications, the test performing unit 163 performs benchmarking tests for applications using the generated test scenarios at step 305. The test performing unit 163 performs a benchmarking test for an application executed to extract the storage approach pattern using a test scenario, and determines representative performing times for applications. The benchmarking tests for applications using the generated test scenarios will be described in more detail with reference to FIG. 6.

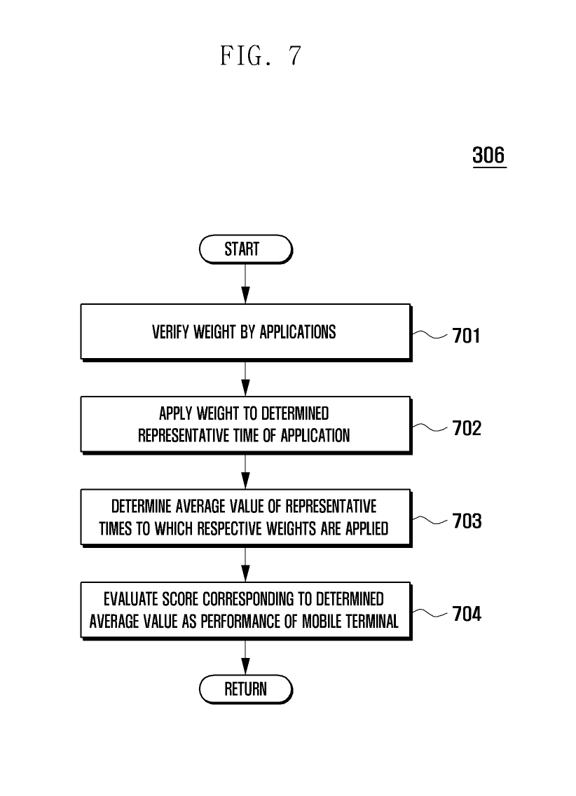

If the test performing unit 163 performs benchmarking tests for applications, the performance evaluating unit 164 evaluates performance of the mobile terminal 100 using results of the performed benchmarking tests at step 306. The performance evaluating unit 164 puts representative execution times for applications together to evaluate the entire performance of the mobile terminal 100. The evaluation of the performance of the mobile terminal using results of the performed benchmarking tests will be described in more detail with reference to FIG. 7.

FIG. 6 is a flowchart illustrating a procedure for benchmarking tests for applications using generated test scenarios according to an exemplary embodiment of the present invention.

Referring to FIG. 6, a test performing unit 163 performs a benchmarking test for one of the applications in which a test scenario is generated according to the test scenario at step 601. In an exemplary implementation, the test performing unit 163 may perform the benchmarking test at step 601 in an execution order of applications at step 302 of FIG. 3. The test performing unit 163 determines an application to be executed by referring to a Test ID and an App Name, executes an application by referring to a Sector Start, a Sector Size, a type (Read/Write) of operation, and executes a next application by referring to a Delay Time between tests.

The test performing unit 163 measures a performance time of a benchmarking test at step 602. After executing the application, the test performing unit 163 measures the time for performing an operation (i.e., read or write) with respect to a corresponding Sector Start and Sector Size.

In an exemplary implementation, the test performing unit 163 performs a benchmarking test for one application plural times, and determines whether the number n of the benchmarking tests is a preset number (N_{T}) at step 603. The N_{T} is the minimum test measuring number required to determine representative time of an application. When the n does not become the N_{T}, the test performing unit 163 returns to step 601 and repeats a benchmarking test for one application. At this time, the test performing unit 163 repeats a benchmarking test by referring to a Delay Time region 505 constituting the test scenario.

If the n becomes the N_{T} at step 603, the test performing unit 163 excludes a maximum value and a minimum value from measured test performance times at step 604. Because the maximum value and the minimum value may be used as error, the test performing unit 163 excludes the maximum value and the minimum value.

Next, the test performing unit 163 determines an average value of remaining test performing times except for the maximum value and the minimum value at step 605. For example, when the test performing unit 163 performs a benchmarking test for one application 13 times, it determines an average value of 11 test performing times except for the maximum value and the minimum value.

Subsequently, the test performing unit 163 determines the determined average value as a representative time of a corresponding application at step 606.

The test performing unit 163 determines whether respective benchmarking test for all test scenarios are performed at step 607. For example, when the approach pattern analyzing unit 162 generates respective test scenarios with respect to five applications at step 304, the test performing unit 163 determines whether benchmarking tests for five test scenarios are all performed at step 607.

When there are test scenarios not performing the benchmarking test, the test performing unit 163 returns to step 601 and performs a benchmarking test according to a next test scenario. At this time, the test performing unit 163 performs a benchmarking test of a next application by referring to a Delay Time region 505 constituting a test scenario.

When the respective bench marking tests for all the test scenarios are performed, the test performing unit 163 terminates the benchmarking test at step 608.

In an exemplary implementation, after step 608, the test performing unit 163 may control the display unit 150 to display representative times determined for every application, respectively. A user may verify the time taken for a storage approach of every application through representative times for the applications.

In addition, the test performing unit 163 may not exclude the maximum value and the minimum value from the measured test performing times, determines an average value of all the measured test performing times, and determines the determined average value as a representative time of a corresponding application.

FIG. 7 is a flowchart illustrating a procedure for evaluating performance of a mobile terminal using results of performed benchmarking tests according to an exemplary embodiment of the present invention.

Referring to FIG. 7, a performance evaluating unit 164 verifies weights by applications at step 701. In an exemplary implementation, users do not use all applications with the same frequency. There are frequently used applications and applications which are not used frequently. The used frequency is a weight which may be applied to evaluate performance of the mobile terminal 100. The weight may be stored in a storage unit 130 as a fixed value for every application, and may be changed according to change in the used frequency. That is, the controller 160 may measure used frequencies by applications, change and set a weight according to the used frequency, and store the set weight in the storage unit 130. Further, the controller 160 measures an I/O overhead. As the I/O overhead increases, the controller 160 may set the weight higher.

The performance evaluating unit 164 verifies weights allotted by applications in which a benchmarking test is performed from the storage unit 130 at step 701.

Next, the performance evaluating unit 164 applies respective weights to determine representative times of an application at step 702. For example, when respective representative times for five applications are determined, the performance evaluating unit 164 multiplies representative times by weights corresponding to respective applications to determine representative times to which five weights are applied, respectively.

The performance evaluating unit 164 determines an average value of the representative times to which the respective weights are applied at step 703. That is, respective benchmarking tests for five applications are performed and the performance evaluating unit 164 determines an average value of five representative times to which respective weights are applied.

Subsequently, the performance evaluating unit 164 evaluates a score corresponding to the determined average value as the performance of the mobile terminal at step 704. A score table composed of average values of representative times to which respective weights are applied is stored in the storage unit 130. For example, the score is set as one from 0 to 10, and respective scores may be set corresponding to a range of average values of representative times to which respective weights are applied. After determining the average value, the performance evaluating unit 164 determines a score corresponding to the determined average value as the performance of the mobile terminal 100.

In an exemplary implementation, the performance evaluating unit 164 may control the display unit 150 to display a performance evaluating score of the mobile terminal 100. Further, in a case where the test performing unit 130 displays representative times and confirm keys of respective applications through the display unit 150, if a user input the confirm key through the input unit 140, after performing step 701 to step 704, the performance evaluating unit 164 controls the display unit 150 to display the performance evaluating score of the mobile terminal 100.

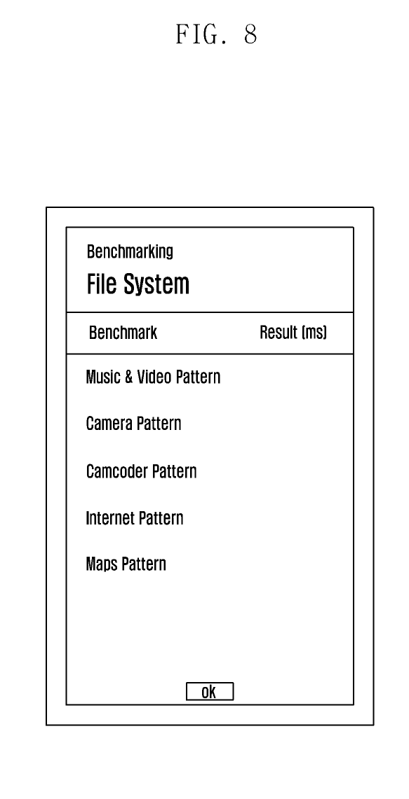

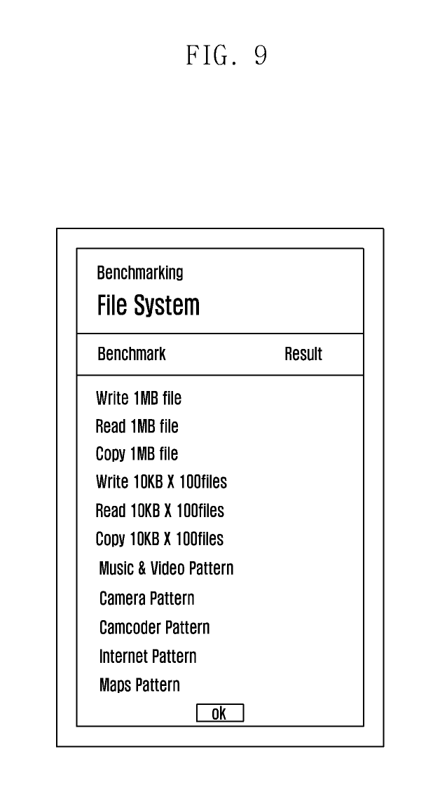

FIG. 8 and FIG. 9 are views illustrating examples of an execution screen of a benchmarking program according to an exemplary embodiment of the present invention, respectively. FIG. 8 and FIG. 9 illustrate screens displaying representative times of respective applications after performing benchmarking tests with respect to respective applications.

Referring to FIG. 8, the execution screen of the benchmarking program illustrates a result display region with respect to a Music & Video Pattern, a Camera Pattern, a Camcorder Pattern, an Internet Pattern, and a Maps Pattern. FIG. 9 illustrates a result display region with respect to a Write 1 MB file, a Read 1 MB file, a Copy 1 MB file, Write 10 KB*100 files, Read 10 KB*100 files, Copy 10 KB*100 files, a Music & Video Pattern, a Camera Pattern, a Camcorder Pattern, an Internet Pattern, and a Maps Pattern. The representative time of applications in which benchmarking tests are performed is displayed on the result display region. After performing the benchmarking tests, the test performing unit 163 controls the display unit 150 to display a benchmarking test result screen illustrated in FIG. 8 or FIG. 9.

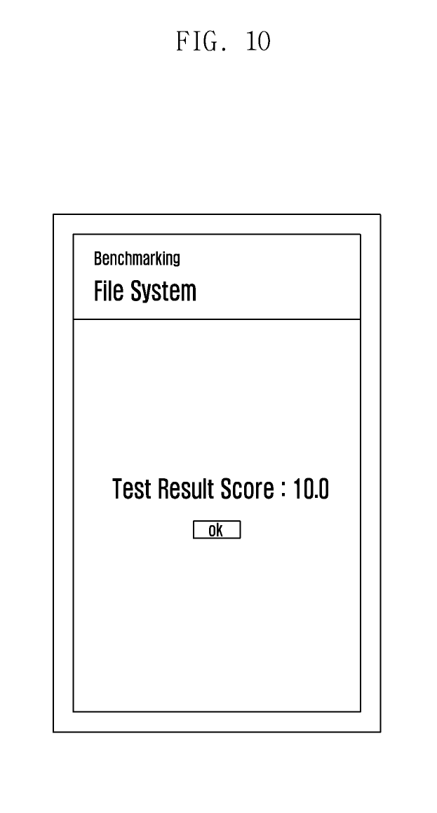

FIG. 10 is a view illustrating an example of an execution screen of a benchmarking program according to an exemplary embodiment of the present invention.

Referring to FIG. 10, the screen of the benchmarking program displays a test result score of the mobile terminal 100.

The test result score is displayed as a ‘Test Result Score: 10.0’ of the mobile terminal 100 and a confirm key is displayed with ‘OK’. A user may confirm performance of the mobile terminal 100 using a screen illustrated in FIG. 10. Further, the user may objectively compare performance of the mobile terminal with each other by confirming performance scores by mobile terminals.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for evaluating performance of a mobile terminal, the method comprising:
executing applications of a preset list;
extracting storage approach patterns for the executed applications;
generating test scenarios for the executed applications using the extracted storage approach patterns;
performing benchmarking tests for the applications using the generated test scenarios; and
evaluating the mobile terminal based on results of the performed benchmarking tests.

2. The method of claim 1, wherein the extracting of the storage approach patterns comprises extracting the storage approach patterns for the executed applications including a current time after booting the mobile terminal, an Elapsed Time of operation, a type (Read/Write) of the operation, a Start Sector which an Input/Output (I/O) Request approaches, and a Sector Size.

3. The method of claim 2, wherein the generating of the test scenarios comprises generating the test scenarios for the executed applications including a Text ID, the Start Sector, the Sector Size, the type (Read/Write) of the operation, a Delay Time with a next test, and an application name.

4. The method of claim 3, wherein the performing of the benchmarking tests comprises:
performing benchmarking tests for the applications of the preset list;
measuring test performing times for applications for preset times;
determining an average value of the measured test performance times for applications; and
determining the determined average value as representative time of a corresponding application.

5. The method of claim 4, wherein the evaluating of the mobile terminal comprises:
verifying weights allotted by applications for which the benchmarking tests are performed;
applying the weights by the applications to the determined representative times of the applications, respectively;
determining an average value of the representative times of the applications to which the weights are respectively applied; and
evaluating a score corresponding to the determined average value as the performance of the mobile terminal.

6. The method of claim 4, further comprising separately displaying the determined representative times of the applications by the applications.

7. The method of claim 1, wherein the executing of the applications comprises executing the applications of the preset list when an execution command for a benchmarking program installed in the mobile terminal is input.

8. The method of claim 1, wherein the executing of the applications comprises executing at least one of an Internet web browser application, a map searching application, a music and video playing application, a photographing application, and a moving image photographing application.

9. A mobile terminal comprising:
a storage unit for storing at least one application and benchmarking program;
an approach pattern extracting unit for extracting storage approach patterns by executed applications;
an approach pattern analyzing unit for generating test scenarios for the executed applications using the extracted storage approach patterns;
a test performing unit for performing benchmarking tests by applications using the generated test scenarios; and
a performance evaluating unit for evaluating performance of the mobile terminal using results of the performed benchmarking tests.

10. The mobile terminal of claim 9, wherein the storage unit stores the extracted approach patterns and the generated test scenarios.

11. The mobile terminal of claim 9, wherein the approach pattern extracting unit extracts storage approach patterns including a current time after booting the mobile terminal, an Elapsed Time of operation, a type (Read/Write) of the operation, a Start Sector in which an input/output (I/O) Request approaches, and a Sector Size for the executed applications.

12. The mobile terminal of claim 11, wherein the approach pattern analyzing unit generates test scenarios by the executed applications including a Text IDentification (ID), the Start Sector, the Sector Size, the type (Read/Write) of the operation, a Delay Time with a next test, and an application name.

13. The mobile terminal of claim 12, wherein the test performing unit performs benchmarking tests for the applications of the preset list, measures test performing times by applications preset times, determines an average value of the measured test performing times by applications, and determines the determined average value as representative time of a corresponding application.

14. The mobile terminal of claim 13, wherein the performance evaluating unit verifies weights allotted by applications for which the benchmarking tests are performed, applies weights by the applications to the determined representative times of applications, respectively, determines an average value of the representative times of the applications to which the weights are respectively applied, and evaluates a score corresponding to the determined average value as the performance of the mobile terminal.

15. The mobile terminal of claim 13, further comprising a display unit for separately displaying the determined representative times of the applications by the applications.
